(19) United States
(12) Patent Application Publication
(10) Pub. No.: US 2026/0366295 A1
(43) Pub. Date: Nov. 19, 2026

(54) Reinforcement Member and Method of Manufacture

(71) Applicants: Quai-de Axam M.A. Edoo, Western Australia (AU); Salvatore A. Saker, Melbourne (AU)

(72) Inventors: Quai-de Axam M.A. Edoo, Western Australia (AU); Salvatore A. Saker, Melbourne (AU)

(21) Appl. No.: 19/135,556

(22) PCT Filed: Dec. 4, 2022
(86) PCT No.: PCT/AU2022/051450

§ 371 Date: Jun. 4, 2025

(51) Int. Cl. E04C 5/07; B29C 70/52; E04C 5/16

(52) U.S. Cl. CPC E04C 5/073; B29C 70/525; E04C 5/166

(57) ABSTRACT

A method of pultruding a reinforcing member, the method comprising producing an elongate, malleable blank and passing the blank through a deformer to deform a surface of the blank before completing a curing process and before cutting the blank to form the reinforcing member. The reinforcing member may be made from fibre-reinforced polymer in which case the method further comprises providing fibre impregnated with a polymer resin; passing the impregnated fibre through a die to form the blank; and curing and cutting the blank after deforming the surface of the blank to form the reinforcing member. A further embodiment extends to a modular system for reinforcing concrete comprising at least one elbow member and at least one straight member wherein the elbow member and the straight member are adapted to engage with one another to form a reinforcing unit wherein the elbow member comprises a single, unitary member.

### TECHNICAL FIELD

Embodiments relate to a matrix material reinforcements and methods of manufacturing concrete reinforcements.

### BACKGROUND

Fibre reinforcement members may, for example, be used to reinforce concrete. Such member as known as a replacement for steel bars. In September 2022, The American Concrete Institute developed and released a set of building code requirements for structural concrete reinforced with glass fibre-reinforced polymer (GFRP) bars. This complements existing building code requirements for concrete structures to facilitate the use of fibre reinforced polymer (FRP).

FRP reinforcement members are known to be manufactured using a composite matrix of fibres and resin. It generally displays characteristics of being lightweight and corrosion resistant with high tensile strength and an improved mechanical performance when compared to steel.

Steel reinforcement members used with concrete, and in other applications, are often formed with surface indents to improve the bond between the member and the concrete (or other matrix). Forming such indents in the surface of an FRP member has been problematic as this affects the strength and integrity of the polymer concerned. An alternative, to improve the adhesion between the member and concrete has been to wind fibres around the member, coat the surface with silica or mill the surface to create an uneven bonding surface, or use other materials, but all of these significantly increase the cost of the members.

One of the disadvantages of FRP reinforcement members over reinforcement members constructed from more traditional materials such as steel is that FRP reinforcement members cannot be bent on site to suit concrete (or other) forms which are not straight or where non-linear reinforcement members are needed, for example, hoops may be required as anchors. Bending of cured FRP results in unacceptable weaknesses, particularly for thermoset resins.

Recently, FRP reinforcement members have been made from thermoplastic resin which allows limited deformation if the member is heated. However, thermoplastic resins suffer from disadvantages such as high viscosity and poor fibre impregnation.

CN103541514A discloses mechanical connectors with a variable angle which can be used to join two FRB bars. The connectors rely on a toothed arrangement which is fixed with a pin to set the angle. Such mechanical arrangement with variable angles significantly add to the cost. The profile of the connectors, being discontinuous with the bars may adversely affect the bond between the matrix and the reinforcing structure.

### SUMMARY OF THE DISCLOSURE

An embodiment provides a method of pultruding a reinforcing member, the method comprising:
producing an elongate, malleable blank and
passing the blank through a deformer to deform a surface of the blank before completing a curing process and before cutting the blank to form the reinforcing member.

The reinforcing member may be made from fibre-reinforced polymer in which case, the method may comprise:
providing fibre impregnated with a polymer resin;
passing the impregnated fibre through a die to form the blank; and
curing and cutting the blank after deforming the surface of the blank to form the reinforcing member.

The reinforcing member may be for reinforcing concrete or other matrices.

The deformer may deform a surface of the blank after the impregnated blank has been passed through the die. The blank may pass through a further die after the deformer has deformed a surface of the blank.

The method may further comprise exposing the blank to a heat source to aid in curing. Curing the blank may comprise processing the blank to set a shape of the blank.

Each die may comprise a heat source and/or one or more heat sources may be provided separately from the die or the further die to aid in curing the blank. Curing may further comprise cooling the blank after the surface has been deformed.

The polymer may be a thermoset polymer or a thermoplastic.

The deformer may deform a surface of the blank before or after the step of curing. This may depend on whether a thermoset or thermoplastic polymer is used.

The deformer may act continuously or discontinuously. The deformer may roll over the surface to be deformed or may be a stamp, or a combination thereof. The deformer may comprise a serrated gear which rolls over the surface of the blank to deform the surface.

The deformer may deform a surface of the blank by forming indents in the surface of the blank. The indents may be crescent-shaped. The surface may be deformed by one or more of: grooves, recesses, dents, ribs, patterns or embossed pattern logos.

The deformer may be heated to assist in the curing.

The deformer may comprise a first deforming element and a second deforming element wherein the first deforming element deforms a first surface of the blank and a second deforming element deforms a second surface of the blank. The first surface may be located opposite to the second surface. One or both of the first deforming element and the second deforming element may be gears. The first deforming element may be connected to the second deforming element so that movement of one of the deforming elements causes movement of the other deforming elements.

The depth of the deformation of the surface of the blank may be limited to avoid damage to the fibres impregnated in the polymer resin.

The deformer may be driven. The deformer may drive the blank through the deformer. The blank may be driven by the deformer through the die or the further die. In general, the deformer may drive the blank through at least part of the pultrusion process. The deformer may be driven by one or more of a chain or belt, wherein the chain and/or belt is connected to a motor.

The method may comprise the step of impregnating the resin with the fibre. The fibre may be organic or non-organic. The fibre may be synthetic.

A further embodiment extends to a reinforcing member made constructed according to the method described.

A further embodiment extends to an elbow member for use in a modular system for reinforcing concrete or other matrix material, wherein the elbow member is adapted to engage with a further member to form a reinforcing unit, wherein the elbow member comprises a single, unitary, non-linear member.

The elbow member comprises a single unitary member and may therefore be precast or moulded. In a preferred embodiment, the elbow member is constructed from FRP. The elbow member may consist of FRP. In a further embodiment, the elbow member is made from a non-metallic material other than FRP, such as a non-reinforced polymer.

A single, unitary elbow member may be cheaper and easier to maintain than a complex mechanical coupling which allows the user to manually set the angle.

A further embodiment extends to a modular system for reinforcing concrete or other matrix material, the modular system comprising an elbow member as described and a further member wherein the elbow member and the further member are adapted to engage with one another to form a reinforcing unit. The further member may be a straight member.

The modular system may comprise more than one straight member. In an embodiment, the elbow member may be adapted to connect to two, or more, straight members. The components of the system comprising any elbow members and any straight members may all be made from FRP, or other non-metallic material. In an embodiment, the components of the modular system are made from a mix of materials including two or more of FRP, and other non-metallic materials.

The elbow member and the straight member may connect directly to one another. The elbow member may be hollow and the straight member may be solid. The elbow member may be solid and the straight member may be hollow. In an embodiment, both the straight members and the elbow members of the modular system are hollow, wherein the elbow member provides a female fitting and one or more straight members provide a male fitting so that each straight member may connect to any elbow member. The straight member may be bonded to the elbow member with an adhesive.

The elbow member may comprise a hollow core so that, when a straight member is engaged with the elbow member, the hollow core forms a channel to accept adhesive. Such a hollow core in the elbow member may improve the bonding between the elbow member the adhesive and the straight member. Similar considerations may apply when an elbow member is used to join two or more straight members.

An advantage of having one of the elbow or straight members as hollow is that this may provide greater surface area for adhesive to interact with. This may improve the bonding strength of the adhesive compared to other arrangements.

The elbow unit may impart any form of non-linearity to the reinforcing unit. For example, the elbow may comprise a right angle bend and may be adapted to engage with two straight members to form a right-angled corner. However, it is to be realised that many other embodiments are possible. Not only is the angle not limited to a right angle, but the elbow may impart other forms of non-linearity to the unit such as a zig-zag, a hoop, a stirrup, an arc, or any other shape which is non-linear.

Since the elbow member is formed as a single, unitary member the bend or other non-linear shape described by the elbow is not manually adjustable. The elbow member may describe an angle wherein the angle is not manually adjustable.

In an embodiment, the modular system comprises a plurality of elbow members, each elbow member defining a different non-linear connector for connecting the straight member. In this embodiment, the user may select the elbow member best suited to the task at hand. Therefore the plurality of elbows may comprise one or more of: a collection of different angles, e.g. 45, 90, and 135, degrees or angles in between as well as one or more of the non-linear shapes: a zig-zag, a hoop, a stirrup, an arc, etc.

The reinforcing unit constructed by connecting one or more straight members to one or more elbows may be used as an anchor. This may be the case where a single straight member is joined to a hook or other non-linear shape.

As used herein “matrix” refers to a material used in producing a composite material and is generally a flowable material such as, without limitation, cement, asphalt, clay, etc.

Each of the elbow members and the straight members may comprise one or more ribs so that when the elbow members connect to the straight members, the one or more ribs are substantially continuous.

At least one of the elbow members or straight members may be provided with surface indents. All of the elbow members and straight members may be provided with surface indents. At least one of the elbow members or straight members may be provided with one or more surface features wherein the surface features may be: wrapped fibres, matt and/or sheet made from glass, Carbon, Basalt, aramid, and other types of organic and synthetic materials. The surface feature may be bonded to the surface of the members using adhesive and/or may be embedded in the surface.

### DESCRIPTION OF THE DRAWINGS

Embodiments are herein described, with reference to the accompanying drawings in which:

FIG. 1 is a schematic representation of a system for producing a reinforcing member made from fibre-reinforced polymer according to a first embodiment;

FIG. 2 is a schematic representation of a system for producing a reinforcing member made from fibre-reinforced polymer according to a further embodiment;

FIG. 3 is a cut-away perspective view illustrating a portion of a die incorporating a deformer;

FIG. 4 is a cut-away perspective view illustrating a portion of a die incorporating a deformer according to a further arrangement;

FIG. 5 is a perspective view of a reinforcing member made from fibre-reinforced polymer;

FIG. 6 is a perspective view of a reinforcing unit according to an embodiment;

FIG. 7 is a perspective view of an elbow for use with a reinforcing unit according to a further embodiment;

FIG. 8 is a perspective view of an elbow for use with a reinforcing unit according to a further embodiment;

FIG. 9 is a perspective view of an elbow for use with a reinforcing unit according to a further embodiment;

FIG. 10 is a perspective view of an elbow for use with a reinforcing unit according to a further embodiment; and

FIG. 11 is a cross section of a reinforcing unit according to an embodiment of the invention.

### DETAILED DESCRIPTION OF SPECIFIC EMBODIMENT

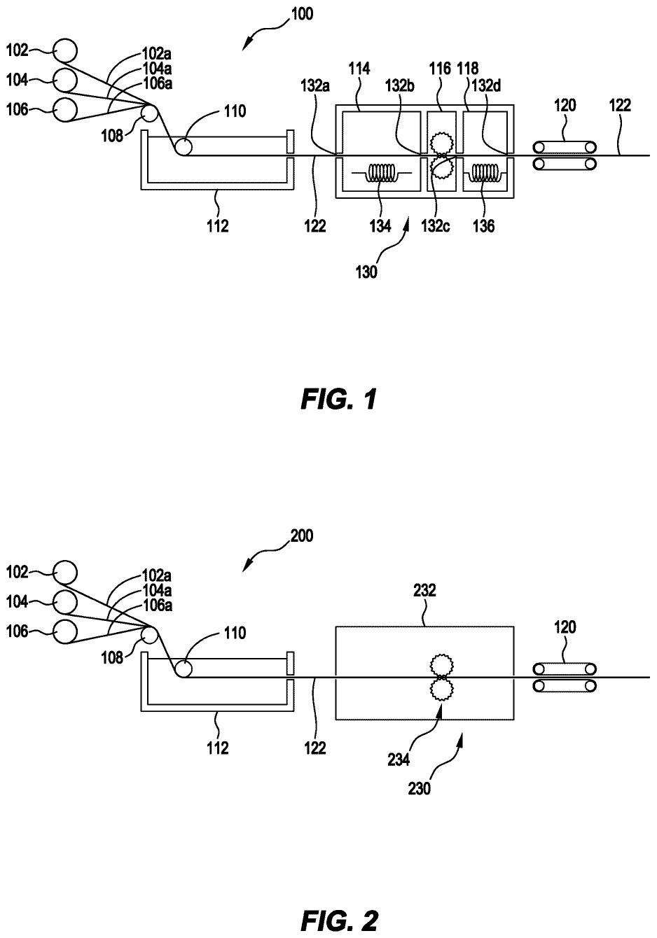

FIG. 1 illustrates a system 100 for producing a reinforcing member made from fibre-reinforced polymer. A plurality of sources of fibre, in this embodiment fibre spools 102, 104 and 106, provide fibre strands 102a, 104a and 106a which are woven and directed by drums 108 and 110 to a polymer bath 112 to produce a raw fibre-impregnated blank 122.

The manner in which such raw fibre impregnated strands are produced are known in the art and will not be described herein in further detail. However it is noted that there are many different types of fibres and polymers which may be used, and different techniques are known for impregnating the polymer with resin.

The raw fibre-impregnated blank 122 is extracted from the bath 112 in substantially the same diameter and outer form as required for the end product. In the case where reinforcing members according to embodiments are made, the blank 122 will have a cross-section of the desired shape and size.

The blank 122 then enters a treatment station 130 which comprises a first setting chamber 114, a deformer 116 and a second setting chamber 118. In this embodiment, the treatment station is provided as a unit, but it is to be realised that different functions may be carried out by physically distinct units where the fibre-reinforced polymer is transported from one unit to another. In any event, where the setting station is provided as a single unit, as shown, the blank 122 is transported through the unit.

In the embodiment shown the transport of the blank from the bath 112 to the setting station 130 is driven by conveyer 120. However, it is to be realised that other forms of providing the necessary force to pull or push the blank through the forming process are known. In an alternative example the blank may be pushed or pulled through the system from elsewhere. In this embodiment, the conveyor 120 includes a blade to cut the blank into the required lengths as the blank is passed through the conveyor. In a further embodiment, discussed in greater detail below, all, or at least some, of the driving force is provided by the deformer 116.

Referring back to the setting station 130, four openings are provided: opening 132a to the setting station 130, opening 132b between the setting chamber 114 and the deformer 116; opening 132c between the deformer 116 and the setting chamber 118; and opening 132d which acts as an outlet to the setting station 130.

In this embodiment, the setting chamber 114 includes a heating element 134 and the setting chamber 118 includes a heating element 136. The heating elements 134 and 136 create the desired environment within the setting chambers to cure the blank into a hardened fibre-reinforced polymer member. The setting chamber 114 provides sufficient curing so that the deformer is able to deform the surface of the blank and the viscosity of the blank is sufficient to generally maintain the deformations created by the deformer 116.

In this embodiment, final setting occurs in the setting chamber 118 where heating element 136 completes the curing process and the hardened fibre-reinforced polymer is then cut to size.

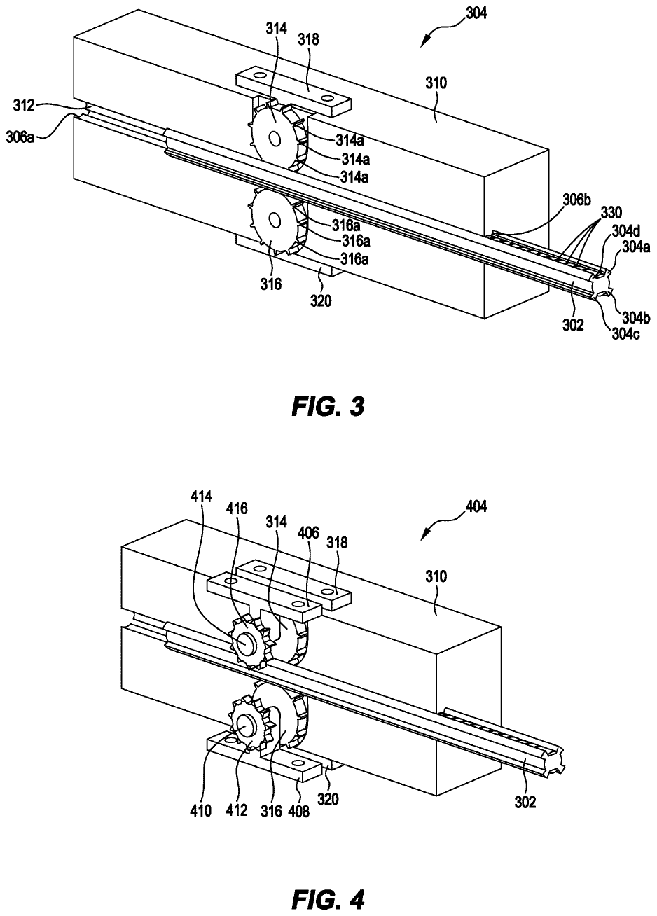

Since the blank 122 is in a malleable form when entering the setting chamber, the opening 132a, as well as the openings 132b, 132c and 132d, to a lesser extent, act as a die on the blank, forming the blank into the cross section desired. It is to be realised that the desired cross-section may depend on the intended function for the finished member. In this embodiment, FIG. 3 illustrates a blank 302 moving through a deformer 304. As illustrated, the blank 302 is formed with ribs 304a, 304b, 304c and 304d which may assist in increasing the effective surface area of the member, once formed. This may provide a more effective reinforcing member.

Therefore, the openings 132a, 132b, 132c and 132d are formed to shape the blank as desired, at least in cross-section. Deformer 304 has openings 306a and 306b which fulfil a similar function.

FIG. 2 illustrates a system 200 for producing a reinforcing member made from fibre-reinforced polymer. The system 200 of FIG. 2 is similar to the system 100 shown in FIG. 1 and described above. Where applicable, like numerals have been used to designate like components. The system 200 of FIG. 2 differs from that of the system 100 of FIG. 1 in that it includes a setting station 230 in place of the setting station 130.

The setting station 230 may perform the same function as the setting station 130 in that it provides an environment to cure or set the blank 122 while providing deformations on the surface of the blank.

The setting station 230 comprises a single setting chamber 232 and deformer 234. The arrangement of the setting station 230 may be cheaper and simpler than that of the setting station 130 of FIG. 1.

It is to be realised that the arrangement and composition of many of the components described above may be varied in a known manner to accommodate members with different compositions. For example, different polymers and polymer-fibre mixes may require different setting environments. In an alternative arrangement, a setting chamber provided down-line from the deformer (similar to the setting chamber 118 illustrated in FIG. 1, is provided, in addition to a heating element, with a cooling element to assist in the setting. The cooling element may be provided instead of the heating element.

Other arrangements involving known curing and setting environments or conditions are also possible.

FIG. 3 illustrates a deformer 304. It is to be realised that the deformer 304 may be used as the deformer 116 of the system 100 of FIG. 1, as the deformer 230 of the system 200 of FIG. 2, or in further embodiments.

The deformer 304 comprises a body 310 made from an appropriate material. A channel 312 is formed longitudinally in the body and is defined by openings 306a and 306b. The channel 312 has a constant cross-section so that as the blank 302 moves through the channel 312, the cross-sectional profile of the blank 302 is at least partially defined by the profile of the channel.

The deformer 304 includes two gears 314 and 316 with respective teeth 314a and 316a. The gears 314 and 316 are each mounted for rotational movement on respective brackets 318 and 320 which are, in turn, mounted to the body 304. The teethed gears 314 and 316 are able to move freely, in this embodiment, relative to the brackets 318 and 320. Furthermore, the gears 314 and 316 are positioned so that the teeth are in contact with a surface of the blank 302 and, as they engage with the blank, cause an indentation or deformation in the surface of the blank.

Therefore, as the blank 302 is moved through the deformer 304 (for example, under the influence of conveyors), the teeth 314a and 316a create indentations 330 in the surface of the blank 302. Furthermore, the movement of the blank 302 through the deformer 304 causes rotation of the gears 314 and 316 so that a continuous or near-continuous repeating pattern may be formed in a surface of the blank.

It is to be realised that the depth, shape and spacing of the indents formed in the blank 302 are determined by the size and number of teeth on the gears 314 and 316, as well as the position of the gears 314 and 316 relative to the blank. By altering these characteristics of the gears and their respective teeth, the characteristics of the indents may be altered accordingly. In further embodiments, the indents or deformations may be grooves, recesses, dents, ribs, patterns or embossed pattern logos. It is to be realised that not all teeth on a gear need be the same and it may be possible, for example, to provide one or more gears with teeth which are different. For example, the teeth may be formed as type so that the indents spell a word, phrase or brand name, for example.

In the arrangement shown in FIG. 3, two deforming elements being gears 314 and 316, are provided. The gears 314 and 316 create indents or deformations on opposed surfaces of the blank 302. However, the number of deforming elements may be varied and their positions varied. It may not be necessary to mark opposed sides and alternative embodiments may have a single deforming element or three, or four, or more deforming elements such as gears. The arrangement and number of the deforming elements may depend on the shape and size of the blank, and therefore on the desired size and shape of the finished member.

FIG. 4 illustrates a deformer 404 according to a further embodiment. The deformer 404 is similar to the deformer 304 illustrated in FIG. 3 discussed above and like numerals are used to denote like components. The deformer 404 differs from the deformer 304 in that the cog 316 is attached to an axle 410 mounted for rotational movement relative to bracket 408. A driving cog 412 is attached to the axle 410. Similarly, the gear 314 is attached to axle 414 mounted in bracket 406 and driving cog 416 attached to the axle 414.

Since rotation of the driving cogs 412 and 414 will cause rotation of respective gears 316 and 314, the deformer 404 may be used to drive the blank 302 through the deformer, and through the system which the deformer forms part of. In an embodiment, a chain may be engaged with the driving cogs 412 and 414 and with a motor (for example) to provide the requisite driving force. Other means for driving the cogs 314 and 316 may be provided. It is to be realised that a driving deformer such as the deformer 404 may be used instead of, or in addition to, the conveyor 120 of FIGS. 1 and 2.

In an alternative arrangement, the driving cogs 412 and 414 may be connected to one another mechanically for example by a belt or cog system. Then, one of the cogs 412 or 414 is attached to a driving source such as a motor, and the mechanical connection ensures that the other cog rotates along with the driven cog.

In an embodiment, the deformer is heated. For example, one or both of the driving cogs 412 and 414 may be heated. Curing by the heated deformer may prevent the deformations from flowing or otherwise returning to their pre-deformed shape, particularly when being pulled by the conveyor in the pultrusion process.

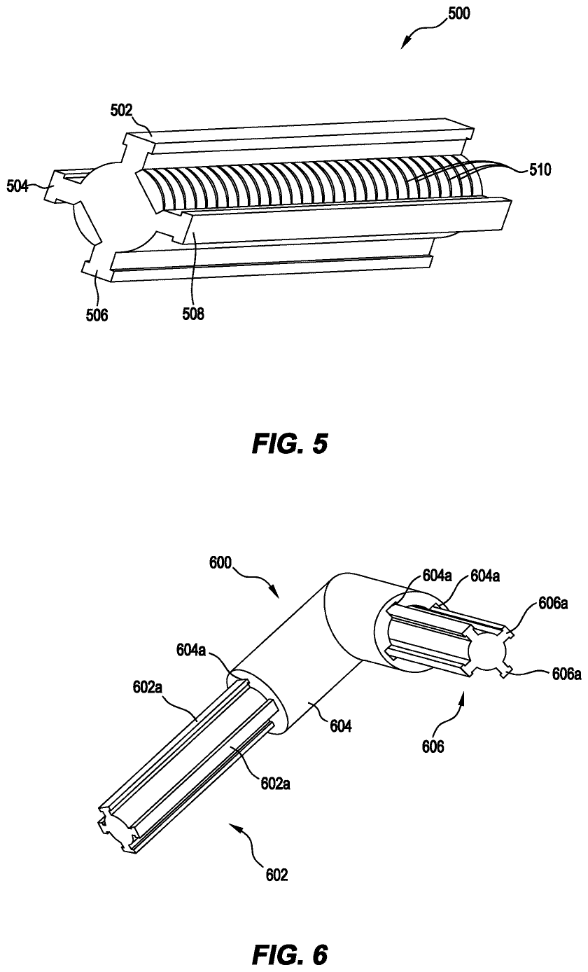

FIG. 5 illustrates a reinforcing member 500 made with the system 100 of FIG. 1 including the deformer 304 of FIG. 3 once the corresponding blank has been cut to size. The member 500 our ribs 502, 504, 506 and 508 and one of the illustrated surfaces is provided with indents 510 formed by a gear as described above. Although not visible in FIG. 5, the surface opposite to the surface with indents 510 is formed with similar indents.

FIGS. 6 to 10 illustrate embodiments of a modular system for reinforcing concrete or other matrix material and components used in such a system.

FIG. 6 illustrates a reinforcing unit 600 comprising a first straight member 602, an elbow 604 and a second straight member 606. The first straight member 602, elbow 604 and second straight member 606 are made from fibre reinforced polymer and the elbow 604 is formed to engage with the first straight member 602 and the second straight member 606. The first straight member 602 and the second straight member are bonded to the elbow 604 through the use of an adhesive.

As illustrated, the straight members 602 and 606 are formed with ribs 602a and 606a. The elbow member 604 is formed with indents 604a which correspond to the ribs 602a and 606a and help to provide improve the bond between the straight members and the elbow member. The multiple grooves/indentations inside the hollow section of the elbow member may provide a mechanical bonding to the FRP bars and make it difficult to pull out under stress.

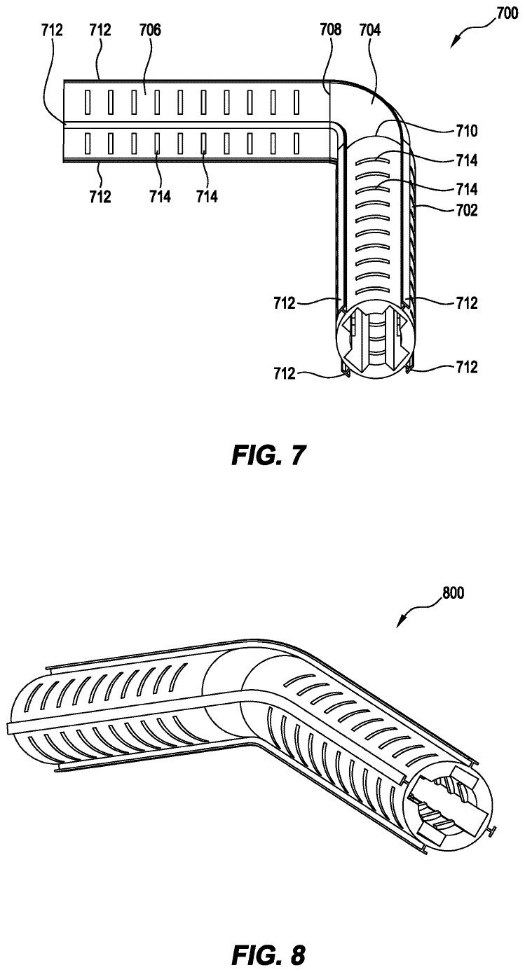

FIG. 7 illustrates an elbow 700 according to a further embodiment. The elbow 700 comprises a first straight coupler 702, a second straight coupler 706 and a bent portion 704 joining, and attached to, the first straight coupler 702 and the second straight coupler 706. As illustrated, the first straight coupler 702 and the second straight coupler 706 are shaped to receive FRP reinforcing members manufactured by the method described above or other pultrusion processes.

In this embodiment, the first straight coupler 702, bent section 704 and second straight coupler 706 are moulded from FRP and joined to one another by welding at joins 708 and 710. Importantly, for embodiments, the resulting elbow 700 is provided as a single unitary member. Once the bent section has been moulded, the angle cannot be altered.

In this embodiment, the first straight coupler 702, bent section 704 and second straight coupler 706 are provided with external ridges 712 and surface indents 714. Such ridges and indents may increase the effective surface area of the elbow 700, therefore improving the boding between the surface of the elbow 700 and the matrix (such as cement) in which the elbow is used.

The elbow 700 acts as a coupler between two straight FRP reinforcement members such as the member 500 illustrated in FIG. 5. Once straight members have been inserted into, and bonded to, the first straight coupler 702 and the second straight coupler 706, a reinforcing unit is produced. In this manner non-linear reinforcing units may be manufactured.

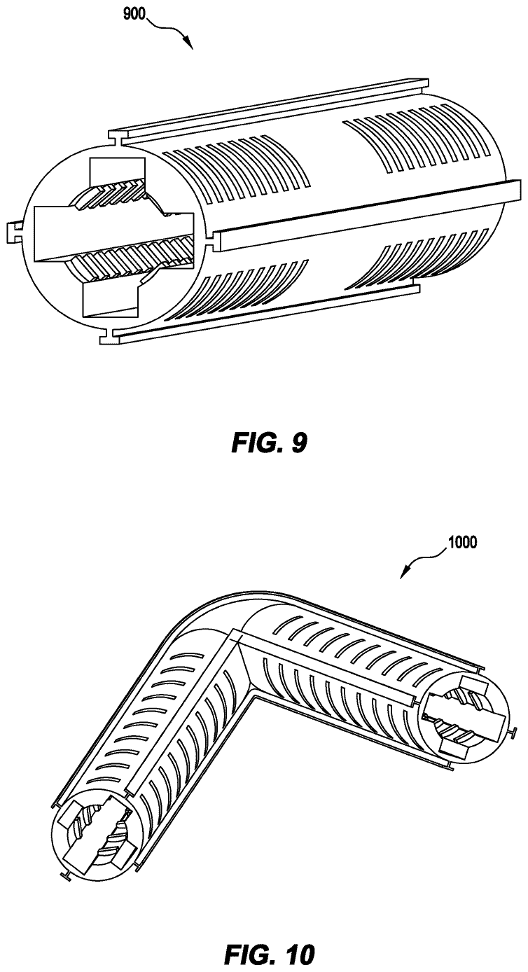

Furthermore, such a modular system may be expanded by providing elbows of varying angles. Whereas the elbow 700 of FIG. 7 describes a right angle, FIG. 8 illustrates an elbow 800 describing an angle of 135 degrees, FIG. 9 illustrates an elbow 900 describing an angle of 180 degrees and FIG. 10 illustrates an elbow 1000 describing an angle of 45 degrees. Since the elbow 900 of FIG. 9 is effectively straight, this provides a straight coupler for two straight members.

In a further embodiment, the elbow couples to a single straight member and is shaped as a zig-zag, a hoop, a stirrup, an arc, etc. Many such shapes are known in the art in use as anchors.

In the embodiments illustrated, the straight members provide the male portion, and the elbow the female portion, of the coupling between the straight portions and the elbow. In further embodiments one or more of the straight members may be hollow, and the elbow may be shaped to engage into the hollow of the straight member.

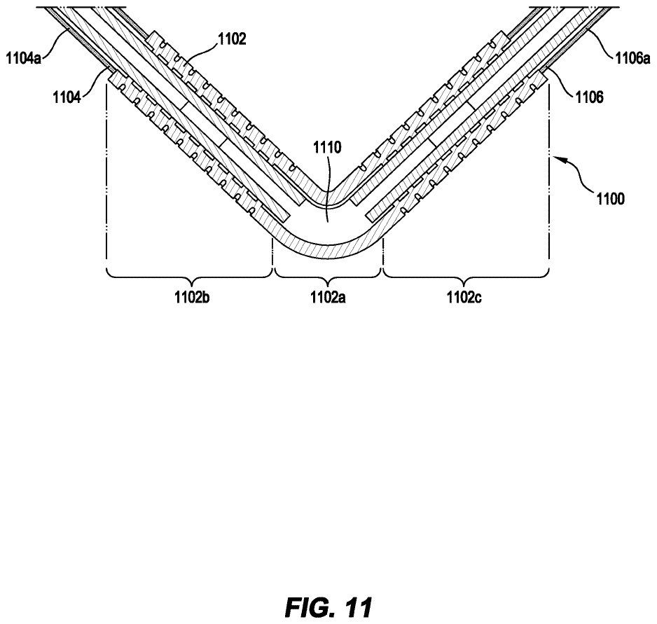

Since an embodiment provides a modular system, the straight members and various elbows such as those described may be manufactured off-site and then brought to the construction site where reinforcing units comprising one or more straight members and at least one elbow are constructed as required. This may be cheaper and more convenient than moulding non-linear FRP reinforcing members as required or providing an adapter with a manually variable angle. FIG. 11 illustrates a reinforcing unit 1100 made according to an embodiment. The reinforcing unit comprises an elbow member 1102, a first straight member 1104 connected to one side of the elbow member 1102 and a second straight member 1106 connected to the other side of the elbow member 1102.

As discussed, the elbow member 1102 and the straight member 1104 are adapted to connect to one another. It is to be realised that different forms of connection are possible, but in the embodiment illustrated, both the straight members 1104 and 1106 as well as the elbow member 1106 are hollow.

The elbow member 1102 comprises a bent portion 1102a joining two straight portions 1102b and 1102c. Furthermore the elbow member 1102 is shaped to fit the straight members within hollow portions of the straight sections 1102b and 1102c. The straight members 1104 and 1106 are accommodated within the hollows of the straight section 1102b and 1102b until the curve of the bent section 1102a prevents further travel.

The hollow section of the bent section 1102a of the elbow member 1102 remains hollow after insertion of the straight members 1104 and 1106 and forms a void 1110 in the reinforcing unit 1100. The elbow member 1102 is bonded to the straight members 1104 and 1106 with the use of an adhesive and the void 1110 provides a channel for the adhesive to flow. It is to be realised that the adhesive will also flow into the hollow sections of the straight members 1104 and 1106. Therefore, the use of hollow straight members and hollow elbow members may provide a secure unit by providing significant surface area with which the adhesive may bond.

As shown in FIG. 11, the straight members 1104 and 1106 comprise respective ribs 1104a and 1106a.

In a further embodiment, the elbow member may be provided with ribs (as illustrated in FIGS. 7 to 10) and the engagement between the elbow member and any straight members is arranged so that when the elbow member connects to the straight members, the one or more ribs of the straight members are substantially continuous with the ribs of the elbow member(s).

In a further embodiment at least one of the elbow members or straight members is provided with one or more surface features wherein the surface features may be: wrapped fibres, matt and/or sheet made from glass, Carbon, Basalt, aramid, and other types of organic and synthetic materials. This may be provided instead or, or as well as, surface indents, and may help to provide adhesion between the resulting reinforcing unit and the matrix material such as cement which the unit is used to reinforce.

It is to be realised that there are other ways in which the straight members and elbow members may interface. Some of the members (straight or elbow) may be solid and others hollow. This may be combined with male/female connectors or other connectors such as snap-fit connectors, in further embodiments.

As used herein, the term “device” shall not be limited to meaning a unitary entity, but covers both a unitary entity and an entity comprising distinct components whether manually removable, or not.

It is to be understood that, if any prior art publication is referred to herein, such reference does not constitute an admission that the publication forms a part of the common general knowledge in the art, in Australia or any other country.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments. Similarly, the word “device” is used in a broad sense and is intended to cover the constituent parts provided as an integral whole as well as an instantiation where one or more of the constituent parts are provided separate to one another.

1. A method of pultruding a reinforcing member, the method comprising:
producing an elongate, malleable blank and
passing the blank through a deformer to deform a surface of the blank before completing a curing process and before cutting the blank to form the reinforcing member.

2. The method according to claim 1 wherein the reinforcing member is made from fibre-reinforced polymer, the method further comprising:
providing fibre impregnated with a polymer resin;
passing the impregnated fibre through a die to form the blank; and
curing and cutting the blank after deforming the surface of the blank to form the reinforcing member.

3. The method according to claim 2 wherein the deformer deforms a surface of the blank after the impregnated polymer has been passed through the die.

4. The method according to claim 3 further comprising passing the blank through a further die after the deformer has deformed a surface of the blank.

5. The method according to any preceding claim further comprising exposing the blank to a heat source to aid in curing.

6. The method according to claim 2 or claims 3 to 5, when dependent on claim 2, wherein each die comprises a heat source and/or one or more heat sources are provided separately from the die or the further die to aid in curing the blank.

7. The method according to any preceding claim wherein curing further comprises cooling the blank after the surface has been deformed.

8. The method according to any preceding claim wherein the deformer rolls over the surface to be deformed.

9. The method according to claim 8 wherein the deformer comprises a serrated gear which rolls over the surface of the blank to deform the surface.

10. The method according to claim 9 wherein the serrated gear deforms the surface of the blank by forming crescent-shaped indents in the surface of the blank.

11. The method according to any preceding claim wherein the deformer is heated to assist in the curing.

12. The method according to any preceding claim wherein the deformer comprises a first deforming element and a second deforming element wherein the first deforming element deforms a first surface of the blank and a second deforming element deforms a second surface of the blank, wherein the first surface is located opposite to the second surface.

13. The method according to claim 12 wherein the first deforming element is connected to the second deforming element so that movement of one of the deforming elements causes movement of the other deforming elements.

14. The method according to any preceding claim wherein the deformer is driven to drive the blank through the deformer.

15. A reinforcing member made from fibre-reinforced polymer constructed according to the method of any of claims 1 to 14.

16. An elbow member for use in a modular system for reinforcing concrete or other matrix material, wherein the elbow member is adapted to engage with a further member to form a reinforcing unit, wherein the elbow member comprises a single, unitary, non-linear member.

17. The elbow member according to claim 16 precast or moulded from fibre-reinforced polymer.

18. A modular system for reinforcing concrete or other matrix material, the modular system comprising at least one elbow member according to claim 16 or 17 and at least one further member wherein the elbow member and the further member are adapted to engage with one another to form a reinforcing unit.

19. The modular system according to claim 18 wherein the further member is a straight member and wherein the elbow member and the straight member are made from FRP.

20. The modular system according to claim 19 comprising more than one straight member wherein the elbow member is adapted to connect to two, or more, straight members.

21. The modular system according to claim 19 or claim 20 comprising a plurality of elbow member and a plurality of straight members wherein both the straight members and the elbow members of the modular system are hollow, wherein the elbow member provides a female fitting and one or more straight members provide a male fitting so that each straight member may connect to any elbow member.

22. The modular system according to claim 21 wherein one or more elbow members comprise a hollow core so that, when a straight member is engaged with the one or more elbow member, the hollow core forms a channel to accept adhesive.

23. The modular system according to any of claims 18 to 22 wherein each elbow member is not manually adjustable.

24. The modular system according to any of claims 18 to 23 further comprising a plurality of elbow members, each elbow member defining a different non-linear connector for connecting the straight member, the plurality of elbows comprising elbow members describing one or more of 45, 90 and 135 degrees or angles in between as well as one or more of the following further non-linear shapes: a zig-zag, a hoop, a stirrup, and an arc.

25. The modular system according to any of claims 18 to 24 wherein each of the elbow members and the straight members comprises one or more ribs so that when the elbow members connect to the straight members, the one or more ribs are substantially continuous.

26. The modular system according to any of claims 18 to 25 wherein at least one of the elbow members or straight members may be provided with surface indents.

27. The modular system according to any of claims 18 to 26 wherein at least one of the elbow members or straight members is provided with one or more surface features wherein the surface features may be: wrapped fibres, matt and/or sheet made from glass, Carbon, Basalt, aramid, and other types of organic and synthetic materials.
